(19) United States
(12) Patent Application Publication
(10) Pub. No.: US 2009/0131237 A1
(43) Pub. Date: May 21, 2009

(54) Drive Unit For A Laboratory Centrifuge

(75) Inventors: Erich R. Soetebier, Halle/Westfalen (DE); Rudiger Rauskolb, Bernau (DE)

Correspondence Address: Barnes & Thornburg, LLP, Suite 900, 750 17th Street, N.W., Washington, DC, 20006, US

(73) Assignee: Hanning Elektro-Werke GmbH & Co., KG, Oerlinghausen (DE)

(21) Appl. No.: 11/873,490

(22) Filed: Oct. 17, 2007

Related U.S. Application Data
(63) Continuation of application No. PCT/EP2006/061678, filed on Apr. 19, 2006.

(30) Foreign Application Priority Data
Oct. 26, 2006 (DE) 10 2005 018 041.8

(51) Int. Cl. B04B 9/00

(52) U.S. Cl. 494/46

(57) ABSTRACT

A drive unit for a laboratory centrifuge, comprising a motor via which a centrifuge rotor that is attached to an inner shaft can be rotated. The motor drives a hollow shaft inside which the inner shaft that is attached in the centrifuge rotor is accommodated at least in part and is mounted to as to be able to oscillate. A spring stabilizer is disposed in the hollow shaft and around the inner shaft, whereby the drive unit is provided with a compact design while vibrations and noise are effectively reduced.

### BACKGROUND AND SUMMARY

The present invention relates to a drive unit for a laboratory centrifuge, comprised of a motor by which a centrifuge rotor attached to a shaft is rotated.

EP 867226 A2 discloses a laboratory centrifuge in which a rotor is spring-loadedly mounted via a shaft. The shaft and bearing is connected to the stator via four spring elements. The spring elements are intended to avoid vibration of the stator of the electric motor. The configuration illustrated is somewhat costly, due to the configuration of the special electric motor.

DE 10038060 A1 discloses a centrifuge with an imbalance compensation device. A shaft carries a centrifuge rotor on one end, and the shaft has compensating rings which support it at a plurality of locations. The elastic bearing system described allows noises, vibrations, and a certain amount of imbalances to be compensated. However, the operating apparatus has a physically very long construction and is unsuitable for small centrifuges. In addition, the elastic bearings cause “walk-through losses” which can only poorly be ameliorated. The bearing structure is therefore thermally critical, limiting the rotational rate.

Further, DE 2854566 A1 discloses a laboratory centrifuge wherein support means are provided outside the motor. The support means (e.g. bearing means) enable a certain radial play of the shaft. In an instance of wobbling of the centrifuge rotor, however, these support means are unable to stabilize the movement of the shaft.

U.S. Pat. No. 4,568,324 discloses a drive unit for a laboratory centrifuge wherein an elastic damping element is disposed between a flexible shaft and a hollow shaft. The damping element rotates with the shaft and is disposed in a widened housing region.

Accordingly, the present drive unit for a laboratory centrifuge has a compact structure and which effectively suppresses wobbling movements of the centrifuge rotor.

The motor drives a hollow shaft, which hollow shaft at least partially accommodates in its interior an inner shaft which is connected to the centrifuge rotor and which inner shaft is oscillatably or cantilever mounted. By means of elastic support means for the inner shaft, imbalances which occur due to nonuniform loading of the centrifuge rotor are effectively de-coupled from the remainder of the apparatus. In particular, vibrations are kept away from the motor bearings and supports and from the housing, thereby enabling high rotational rates to be achieved with the present drive unit. A compact structure is achieved in that the hollow shaft and inner shaft, to which inner shaft the centrifuge rotor is connected, are telescopically arranged, thereby reducing the installation length.

Under this arrangement, the motor essentially surrounds the hollow shaft. Depending on the particular bearing and support system for the hollow shaft, the hollow shaft may extend slightly out of the housing. But for an optimally compact structure, the hollow shaft may be fully accommodated in the housing.

At least one spring stabilizer having spring properties is disposed in the hollow shaft in the motor, and the stabilizer surrounds the inner shaft. In particular the stabilizer is disposed in a gap between the hollow shaft and the inner shaft. The spring stabilizer may be mounted in an extremely simple manner in the hollow shaft, wherewith the spring constants and damping constants can be chosen depending on the configuration of the centrifuge rotor.

The inner shaft is attached to the hollow shaft at the end region of the inner shaft which is opposite to the end at which the centrifuge rotor is disposed. This attachment can be accomplished via a press fit or other fixing means. This provides a rotationally rigid connection, wherewith the motor can rotate the inner shaft via the hollow shaft, even under conditions of high acceleration or deceleration.

To achieve a short overall structure, the spring element is disposed inside a motor housing, so that only the inner shaft, which is connected to the centrifuge rotor, extends outside the housing.

According to a refinement, sensors for rotational rate or speed and imbalance are provided on the hollow shaft. The rotational speed may be determined with the aid of Hall sensors, optical sensor means, or other sensor elements. An acceleration sensor is also provided on the same support plate as the other sensors, for detection of imbalances.

The motor has a stator assembly, and insulator plates for the stator end windings are provided on both sides of said stator assembly. The flattish end windings may be surrounded by insulating pieces, to facilitate a particularly compact structure of the motor, wherewith the separation distances of the insulating pieces can be kept small. Also, the insulating pieces allow electrical safety requirements to be satisfied, which require a safe and reliable separation between the motor and the contactable parts of the centrifuge. The insulation plates and insulating pieces comply with a requirement of double insulation between the stator winding and the rotor, in particular between the stator winding and the drive shaft assembly.

For particularly good damping of vibrations and suppression of wobbling, the spring stabilizer is comprised of an outer ring which is lodged against the hollow shaft and an inner ring which is lodged against the inner shaft. Thus, one or more spring elements are disposed, e.g. rotationally symmetrically around the axis. The inner ring may surround the inner shaft in a close fit, and may be in forcible engagement with the inner shaft. It is advantageous that the length of the spring stabilizer is greater than its diameter, preferably a multiple of the diameter.

In order to be able to absorb vibration of the inner shaft by the spring means provided, at least one spring stabilizer is disposed closer to the centrifuge rotor than the end of said inner shaft which end is fixed in the hollow shaft. Thus, the configuration of the spring stabilizer may depend on the length of the inner shaft and the weight of the centrifuge rotor. In any event, the combination of elastic inner shaft and spring stabilizers allows the centrifuge rotor to be displaced radially and enables effective suppression of wobbling movements of the centrifuge rotor, particularly such wobbling as may occur when the rotational rate is at certain “critical rotational speeds”. Thus the spring stabilizer has the desired stabilizing effect. Thereby vibration which can arise through imbalances in the loading of the centrifuge rotor are de-coupled from the bearing system of the hollow shaft and from the stator. Noise is reduced, and bearing stress is kept low.

Inexpensive standard bearings may be used for the bearing system of the hollow shaft, even when the apparatus will be operating at high rpm.

Preferably the diameter of the inner shaft is small, 4-10 mm, particularly 5-8 mm. The small shaft diameter is attended by low thermal conduction, as a result of which the risk of heat influence on the samples is reduced.

The present drive unit will be described in more detail hereinbelow with reference to the accompanying drawings.

### BRIEF DESCRIPTION OF THE DRAWINGS

FIG. 1 is a schematic cross sectional view of the present drive unit;

FIG. 2 is a cross section of an exemplary embodiment of the drive unit; and

FIGS. 3A and 3B are two views of the spring element of the drive unit according to FIG. 2.

### DETAILED DESCRIPTION

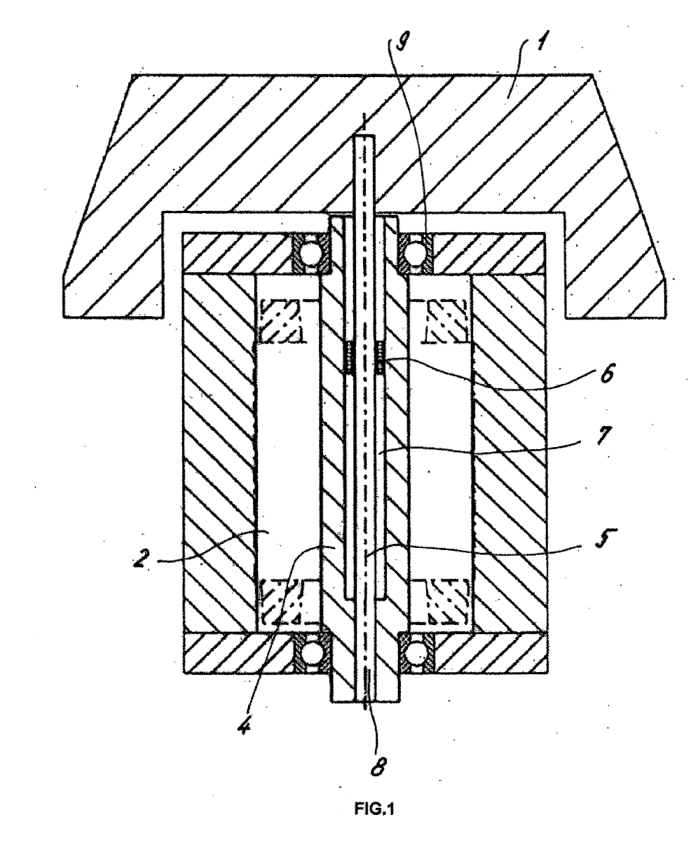

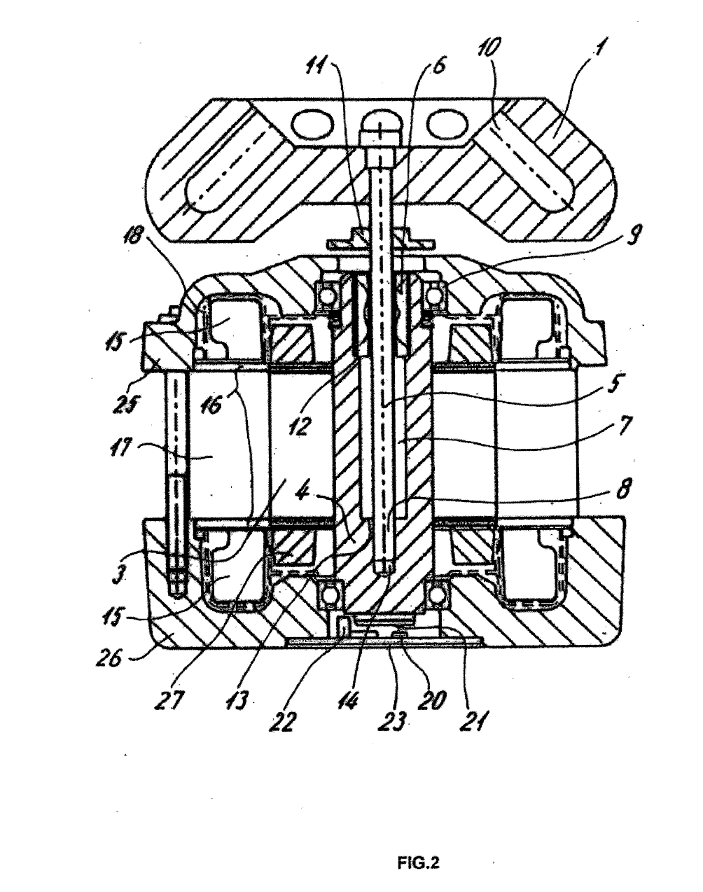

A laboratory centrifuge comprises a centrifuge rotor 1 in which samples can be disposed. The centrifuge rotor 1 is driven by a motor 2 which is shown only schematically in FIG. 1, which motor is disposed in a housing 3, shown in FIG. 2. The motor 2 drives a hollow shaft 4 which accommodates and holds inside it an inner shaft 5 of a lesser diameter. One end region 8 of the shaft 5 is disposed in a press fit inside the hollow shaft 4, and the opposite end of inner shaft 5 carries the centrifuge rotor 1.

The inner shaft 5 is oscillatably or cantileverly mounted between the centrifuge rotor 1 and the end region 8. A gap 7 is provided between the inner wall of the hollow shaft 4 and the outer wall of the inner shaft 5. A spring stabilizer 6, stabilizer having spring properties, is disposed in the gap 7. The stabilizer 6 springingly absorbs vibrations resulting from nonuniform loading of the centrifuge rotor 1, and stabilizes wobbling movements.

The drive unit of FIG. 1 is shown only schematically; FIG. 2 reveals more details.

The inner shaft 5 is elastically mounted via the spring stabilizer 6, whereas the hollow shaft 4 is mounted on the housing via ball bearings 9, because possible vibrations between the shaft 5 and the hollow shaft 4 and motor 2 are decoupled. The ball bearing 9 near the spring stabilizer 6 is held externally against an upper bearing bracket 25, and the lower ball bearing 9 is held against a lower bearing bracket 26 which is connected to the bearing bracket 25. Standard bearings without oil lubrication may be provided for the rotational support of the inner shaft 5.

The centrifuge rotor 1 has a number of recesses 10 disposed at an angle to the shaft 5, into which recesses samples may be inserted. In order to avoid undesired heating of the samples, inner shaft 5 has a small diameter, whereby only a small amount of heat can be conducted to the centrifuge rotor 1. Further, air in the gap 7 serves as an insulator.

A shield ring 11 is disposed between the centrifuge rotor 1 and the housing 3, which ring covers the opening in the housing through which the inner shaft 5 extends. This prevents condensation water which may arise from cooling of the centrifuge rotor 1 from penetrating between the inner shaft 5 and hollow shaft 4, which water might damage the bearing and support system.

The spring stabilizer 6 is secured axially by an indentation 12 which serves as a detent against which an end face of the spring stabilizer 6 is lodged. In the other region between the spring stabilizer 6 and the end region 8 of the inner shaft 5, a gap 7 is provided. In the end region 8, a second indentation 13 is provided which adjoins a bore 14 in which the end region 8 of the inner shaft 5 is held in a press fit.

The motor 2 comprises a flattish stator end winding 15 which is separated from the stator assembly 17 of the motor 2 by an insulating plate 16. A formed insulating piece 18 is disposed around the end winding 15, such that the end winding is doubly insulated with respect to its surroundings. The end winding 15 has a curved cross section so as to occupy a minimum height.

A magnet 21 is fixed to the end of the hollow shaft 4, which magnet is disposed close to a Hall sensor 20. This allows determination of the rotational rate or speed of the hollow shaft 4 and thereby of the centrifugal rotor 1. An acceleration sensor 22 is also provided at the same location, which enables deflections of the motor 2 to be detected when the load on the centrifuge rotor is excessively unbalanced. The acceleration sensor 22 and the Hall sensor 20 are mounted on a printed circuit board or the like 23 which also closes off the opening at the lower bearing bracket 26.

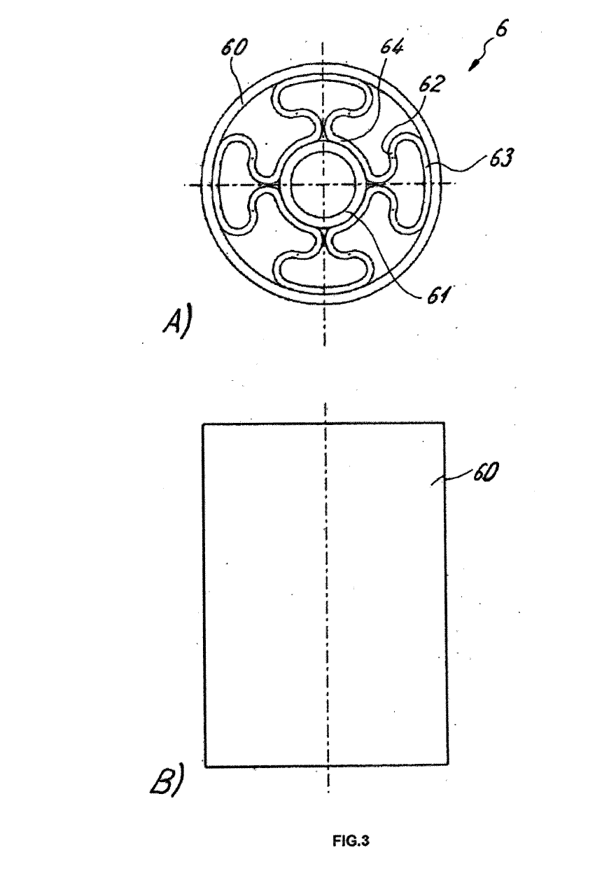

FIGS. 3A and 3B illustrate in detail a possible embodiment of the spring stabilizer 6. The spring stabilizer 6 is comprised of sheet spring steel enclosed in an elastomer or other elastic material, having an outer ring 60 which can be lodged against the hollow shaft 4 and an inner ring 61 which can be pushed over the inner shaft 5. The contacts thereby established can be provided with a certain prestressing. One or more curved spring elements 62 are disposed between the outer ring 60 and the inner ring 61. Regions 63 of these spring elements press against the outer ring 60, and regions 64 of the spring elements press against the inner ring 61. These spring elements 62 allow the outer ring 60 to move radially relatively to the inner ring 61. This provides a certain elasticity and in particular provides damping. The inner ring 61 fits closely against the inner shaft 5. In order to stabilize wobbling of the centrifuge rotor, the axial extent of the spring stabilizer 6 is appreciably greater than the outer diameter of the stabilizer 6.

Clearly, the actual configuration of the stabilizing element 6 may vary widely. E.g., depending on the expected loads, relatively soft gel-like materials, or relatively hard plastic materials, may be used.

Only one spring stabilizer 6 is provided between the hollow shaft 4 and the inner shaft 5, in the exemplary embodiment illustrated. Clearly it is possible to devise a configuration with a plurality of spring elements. Further, the spring stabilizers 6 may be distributed along the inner shaft 5 and may have different spring constants. The spring stabilizers 6 may be comprised of an elastic filling material.

Variations are also possible in the configuration of the motor and the hollow shaft. The length of the interior shaft in the hollow shaft may differ depending on the loads present.

Although the present disclosure had been described and illustrated in detail, it is to be clearly understood that this is done by way of illustration and example only and is not to be taken by way of limitation. The scope of the present disclosure is to be limited only by the terms of the appended claims.

1. A drive unit for a laboratory centrifuge, comprised of a motor by which a centrifuge rotor attached to an inner shaft is rotatable, the motor surrounds and drives a hollow shaft, the shaft is at least partially accommodated and cantileverly mounted in the interior of the hollow shaft at the end region of the inner shaft which is opposite to the end at which the centrifuge rotor is disposed, the hollow shaft is mounted externally on a housing by bearings and
at least one spring stabilizer is disposed inside the motor in the hollow shaft and is disposed around the inner shaft, at a location adjoining or below the bearing at an upper bearing bracket.

2. A drive unit according to claim 1; including means of determining the rotational speed and means of determining an imbalance which are disposed on a support plate adjacent hollow shaft, in a motor housing.

3. A drive unit according to claim 1, wherein the motor has a stator assembly having insulating plates and end windings on each side, and the end windings of the motor are generally surrounded by insulating pieces.

4. A drive unit according to of claim 1, wherein the spring stabilizer is comprised of one or more spring elements which are comprised of flattish spring material.

5. A drive unit according to claim 1, wherein the spring stabilizer is comprised of an outer ring which is lodged against at least one of the hollow shaft and an inner ring which is lodged against the inner shaft, and one or more spring elements comprised of flattish spring material is disposed between said rings.

6. A drive unit according to claim 1; wherein the spring stabilizer is comprised of one or more spring elements which have a curved shape.

7. A drive unit according to claim 5; wherein the one or more spring elements have a curved shape, and one or more regions of these spring elements press against at least one of the outer ring and the inner ring.

8. A drive unit according to claim 1 wherein at least one spring stabilizer has a length greater than its diameter.

9. A drive unit according to claim 1 wherein at least one spring stabilizer is disposed closer to the centrifuge rotor than to the inner shaft end fixed in the hollow shaft.

10. A drive unit according to claim 1, wherein the spring stabilizer is secured in the axial direction.

11. A drive unit according to claim 1, wherein the spring stabilizer is of unit construction.

12. A drive unit according to claim 1, wherein standard bearings without oil lubrication are provided for the rotational support of the inner shaft.

13. A drive unit for a laboratory centrifuge, comprised of a motor by which a centrifuge rotor attached to an inner shaft is rotatable; the motor drives a hollow shaft; and the inner shaft is at least partially accommodated and canterleverly mounted in the interior of the hollow shaft.
